(19) United States
(12) Patent Application Publication
(10) Pub. No.: US 2019/0263225 A1
(43) Pub. Date: Aug. 29, 2019

(54) Air Transfer Apparatus, Method Of Operating The Same And Kit Containing An Air Transfer Apparatus

(71) Applicants: Dominic GRÉGOIRE, L'Orignal (CA); Louis GRÉGOIRE, Gatineau (CA)

(72) Inventors: Dominic GRÉGOIRE, L'Orignal (CA); Louis GRÉGOIRE, Gatineau (CA)

(21) Appl. No.: 16/288,889

(22) Filed: Feb. 28, 2019

Related U.S. Application Data
(60) Provisional application No. 62/636,227, filed on Feb. 28, 2018.

(51) Int. Cl. B60H 1/26; F16L 11/11; F16L 11/15

(52) U.S. Cl. CPC B60H 1/26; F16L 11/15; F16L 11/11

(57) ABSTRACT

An air transfer apparatus for transferring air from an air supply to a restricted environment is provided. The apparatus can include a tubing assembly cooperating with the air supply to provide an airflow to a separate environment. The apparatus can further include an attachment being in fluid communication with the tubing assembly. The attachment being further insertable within the restricted environment. The apparatus can also include a ventilator operably connected to the tubing assembly, wherein operating the ventilator favors the production of airflow from the air supply to the restricted environment. Also, a method of use is provided. Finally, a kit comprising the air transfer apparatus is provided.

### CROSS-REFERENCE TO RELATED APPLICATIONS

This application claims priority to U.S. Provisional Application No. 62/636,227, filed Feb. 28, 2018, the entire contents of which are incorporated by reference herein.

### TECHNICAL FIELD

The technical field generally relates to air transfer devices. More particularly, the present disclosure relates to an air transfer apparatus for supplying air to restricted environments, a method of operating such an apparatus, a kit comprising an air transfer apparatus and related use thereof.

### BACKGROUND

People do not realize that pets can suffer from heat exhaustion and heat strokes like humans can. According to recent studies, if a dog is left within a vehicle during a hot and sunny day, it only takes a few minutes before its life becomes endangered. Even if the windows are completely open, which never happens (otherwise the dog would jump out), the temperature within a parked vehicle rises alarmingly quickly. Inversely, during winter, pets may be exposed to cold temperatures.

Despite this information, dogs are often found locked in cars while their owners go about shopping or eating at restaurants. Most of the time, preferably during summer, people only allow a small opening of one or more windows. Such a small opening is, of course, not sufficient to prevent a rise of the temperature inside the parked vehicle. While breaking the vehicle's windows can be tolerated if a human infant is left within a vehicle, the same cannot be said for a dog. Perpetrators can be fined for the damages done to the vehicle while the owner of said vehicle will not be penalized for having left their pet under lock, inside the vehicle.

Therefore, there is a need for a system or apparatus which would allow a person to provide fresh air to the interior of a vehicle where a pet, or other living being, has been left, especially during hot and sunny days, without damaging said vehicle.

Also, there is a need for a system or apparatus which would allow a person to provide warmed air to the interior of a vehicle where a pet, or other living being, has been left, especially during winter. A person could also use this system or apparatus to provide fresh air (cold or warn) to a human being accidentally stuck into a vehicle or a different location (e.g. a restricted environment, namely a catastrophic disaster) in an emergency situation.

### SUMMARY

According to an aspect, an air transfer apparatus for transferring air from an air supply to a restricted environment is provided. The air transfer apparatus includes a tubing assembly having an inlet and an outlet. The inlet cooperates with the air supply to produce an airflow within the tubing assembly. The air transfer apparatus further includes an attachment removably connected to the outlet, the attachment being in fluid communication with the tubing assembly. The attachment has an opening insertable within the restricted environment. Finally, the air transfer apparatus includes a ventilator operably connected to the tubing assembly. Operation of the ventilator directs the airflow within the tubing assembly towards the outlet thereof, and within the restricted environment via the attachment.

According to a possible embodiment, the opening is manually adjustable to allow insertion within the restricted environment.

According to another possible embodiment, the attachment is tubular and comprises a rigid base connectable to the outlet.

According to another possible embodiment, the attachment is substantially straight.

According to another possible embodiment, the attachment is L-shaped.

According to another possible embodiment, the opening has a periphery provided with an outer flange.

According to another possible embodiment, the tubing assembly includes an upstream tube provided with the inlet, and a downstream tube provided with the outlet, the upstream and downstream tubes being in fluid communication with one another.

According to another possible embodiment, the upstream tube and/or the downstream tube is provided with an accordion section to increase flexibility and allow a longitudinal expansion thereof.

According to another possible embodiment, the accordion section extends for an entire length of the tubes.

According to another possible embodiment, the ventilator is a portable fan having a first side and a second side, the upstream tube being operably connected to the first side, and the downstream tube being operably connected to the second side.

According to another possible embodiment, the ventilator is connectable to a standard DC connector.

According to another possible embodiment, the airflow is between about 150 CFM and about 270 CFM during operation of the ventilator.

According to another possible embodiment, the inlet is provided with a grate.

According to another possible embodiment, the air supply is an air conditioning vent, or a heating vent, preferably the air conditioning vent or heating vent of a vehicle.

According to another possible embodiment, the restricted environment is a vehicle.

According to a second aspect, a kit including the air transfer apparatus, as described above, and a plurality of rescue tools is further provided.

According to a possible embodiment, the rescue tools of the kit are selected from a group consisting of a water bottle, a towel, a sun shade cover, a thermoreflective cover, a window-punch, a knife, a digital temperature reader, a flashlight, a distress light, and an AC to DC adapter.

According to a third aspect, a method of providing an airflow to a restricted environment using the air transfer apparatus as described above is provided. The method comprising the steps of:
a. connecting the attachment to the outlet of the tubing assembly;
b. manually adjusting/squeezing the attachment to insert the opening within the restricted environment;
c. positioning the inlet in a manner cooperating with the air supply;
d. operating the ventilator to provide airflow to the restricted environment.

According to yet another aspect, a use of the air transfer apparatus, as described above, for providing an airflow to a restricted environment is provided.

According to still another aspect, a use of the air transfer apparatus for rescue operations is provided.

According to yet another aspect, a use of the air transfer apparatus, as described above, for transferring an airflow from a first vehicle to a second vehicle is provided.

### BRIEF DESCRIPTION OF THE DRAWINGS

FIG. 1 is a top perspective view of an air transfer apparatus, according to an embodiment, showing a pair of tubes connected to a ventilator.

FIG. 2 is a perspective view of the ventilator, in accordance with an embodiment.

FIG. 3 is a sectional view of each end of the air transfer apparatus, showing a grate installed on one the ends, according to an embodiment.

FIG. 4 is a perspective view of an attachment, according to an embodiment.

FIG. 5 is a perspective view of an air transfer apparatus, having the attachment of FIG. 4 connected thereto, according to an embodiment.

FIG. 6 is a perspective view of an attachment having an L-shape, according to an embodiment.

FIG. 7 is a sectional view of an air transfer apparatus having the attachment of FIG. 6 connected thereto, according to an embodiment.

FIG. 8 is a schematic view of an air transfer apparatus positioned on the floor of a vehicle, showing the ventilator being connected to an outlet of the vehicle, according to an embodiment.

FIG. 9 is a schematic view of an air transfer apparatus positioned on the floor of a vehicle in order to cooperate with an air conditioning vent thereof, according to an embodiment.

FIG. 10 is a rear view of an air transfer apparatus being operated to transfer air from a first vehicle to a second vehicle having a dog inside, according to an embodiment.

### DETAILED DESCRIPTION

Various embodiments are described in the following disclosure with reference to the accompanying figures. It should be understood that the elements of these figures are not necessarily depicted to scale, since emphasis is placed upon clearly illustrating the elements and structures of the present embodiments. In the following description, the same numerical references refer to similar elements. Furthermore, for the sake of simplicity and clarity, namely so as to not unduly burden the figures with several reference numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

As will be explained below in relation to various embodiments, an air transfer apparatus and corresponding kit are provided. Broadly described, the apparatus cooperates with an air supply in order to provide an airflow (i.e. fresh or warmed air) to a separate environment, such as an environment with restricted or limited access, for example. It will become apparent upon reading this disclosure that the air transfer apparatus can be used with any other suitable environment. The air transfer apparatus can include, among other components, a tubing assembly adapted to effectively transfer the airflow from the air supply to the separate environment. Moreover, the apparatus can include an attachment connectable to the tubing assembly and being adapted to be inserted within the restricted environment. Finally, the apparatus can include a ventilator adapted to direct the airflow along the tubing assembly.

Moreover, it will be appreciated that positional descriptions such as “longitudinal”, “transversal”, “left”, “right”, “upper”, “lower”, “external”, “internal”, “outer”, “inner”, “oblique”, “parallel”, “perpendicular” and the like should be taken in the context of the figures only and should not be considered limiting.

In addition, although the optional configurations as illustrated in the accompanying drawings comprises various components and although the optional configurations of the apparatus as shown may consist of certain geometrical configurations as explained and illustrated herein, not all of these components and geometries are essential and thus should not be taken in their restrictive sense, i.e. should not be taken as to limit the scope of the present disclosure. It is to be understood that other suitable components and cooperations thereinbetween, as well as other suitable geometrical configurations may be used for the air transfer apparatus, and corresponding parts, as briefly explained and as can be easily inferred herefrom, without departing from the scope of the disclosure.

In some embodiments, the air transfer apparatus can be particularly useful in providing fresh air to a pet, or any other animal, that has been left within a vehicle, especially on a hot and sunny day. Inversely, during cold winter days, the air transfer apparatus can be adapted to provide warmed air to pets, or any living being, which has been left within a parked car, or is stranded in a restricted/hard to access environment. Furthermore, the various embodiments of the apparatus described herein can be adapted and/or configured for rescue operations, being part of a kit comprising a plurality of devices, for example. It is appreciated that aspects and/or advantages described in conjunction with a particular embodiment are not necessarily limited to that singular embodiment and can be practiced/achieved in any other embodiments even if not so illustrated and/or described.

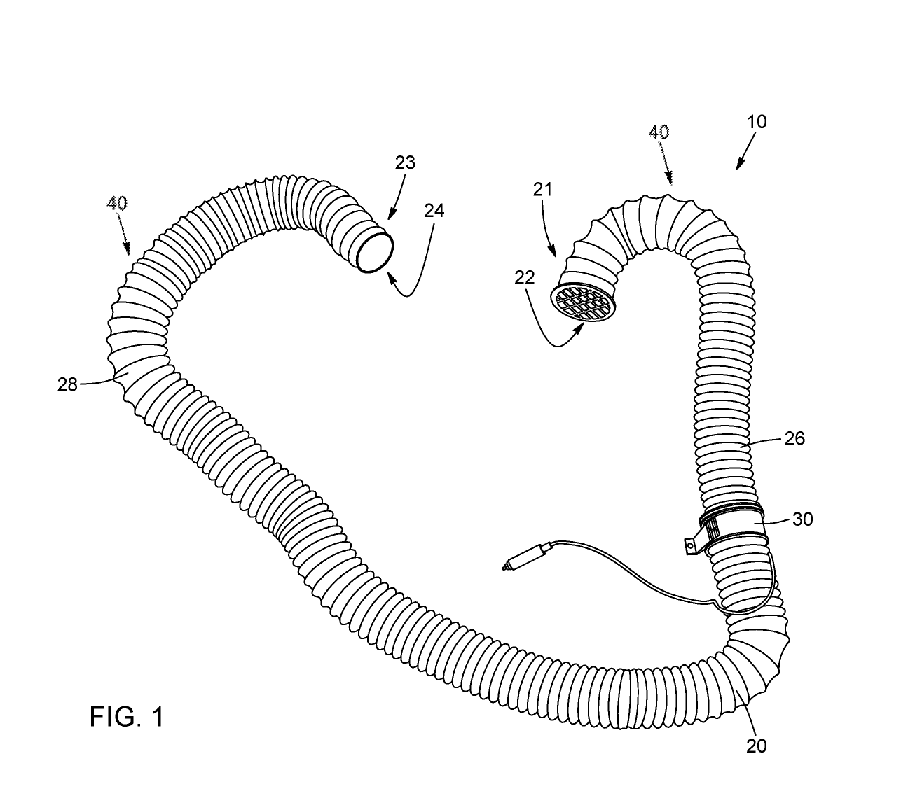

With reference to FIG. 1, an air transfer apparatus 10 is shown according to an embodiment. The apparatus 10 can include a tubing assembly 20 adapted to cooperate with an air supply in order to transfer an airflow, provided by said air supply, to a second/separate environment. In this embodiment, the tubing assembly 20 can establish fluid communication between the air supply and the second environment in a manner that will be described below. The tubing assembly 20 can include an inlet 22 provided at a first end 21 thereof, and an outlet 24 provided at a second end 23 thereof, opposite the first end 21. It should be understood that the inlet 22 can be adapted to cooperate with the air supply, and the outlet 24 can be adapted to cooperate with the second environment. A person of skill in the art will readily understand that the flow of air can therefore be transferred from the air supply to the restricted environment by travelling through the tubing assembly 20. In some embodiments, the second/separate environment is a restricted environment. It should be understood that, in the context of this disclosure, the expression “restricted environment” can refer to a room (or portion thereof) and/or an object comprising an inner volume having a restricted opening or restricted access thereto.

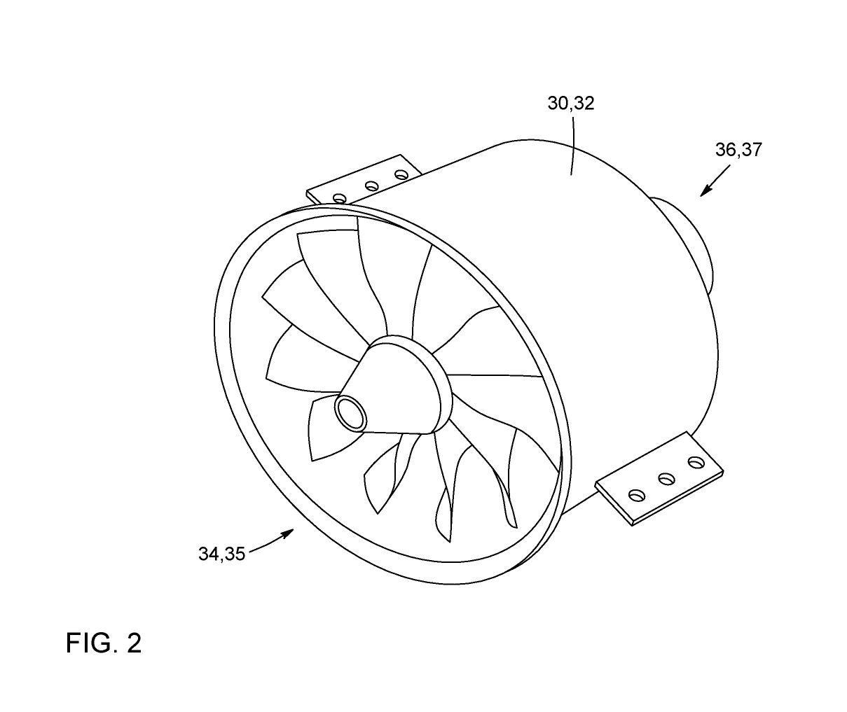

Now referring to FIG. 2, in addition to FIG. 1, the apparatus 10 further includes a ventilator 30 operably connected to the tubing assembly 20. The ventilator 30 can be adapted to direct the airflow along the tubing assembly 20 upon operation thereof. As seen in FIG. 2, a non-limiting example of the ventilator 30 can be a portable fan 32 having a first side 34 opposite a second side 36. In some embodiments, the first side 34 is an upstream side 35 adapted to pull the surrounding air toward it, while the second side 36 is a downstream side 37 adapted to push the air away from the ventilator 30. Furthermore, the tubing assembly 20 can comprise an upstream tube 26 and a downstream tube 28 operably connected to the ventilator 30. More specifically, the upstream tube 26 includes a first end provided with the inlet 22, and a second end operably connected to the first side/upstream side 34, 35 of the ventilator 30. Similarly, the downstream tube 28 includes a first end provided with the outlet 24 and a second end operably connected to the second side/downstream side 36, 37 of the ventilator 30. Therefore, each tube can be in fluid communication with one another such that the airflow provided by the air supply is pulled within the upstream tube 26 and is subsequently pushed out the downstream tube 28 upon operation of the ventilator 30. However, it is appreciated that other configuration of the tubing assembly 20 can be suitable. For example, the tubing assembly 20 can include a single tube fluidly connecting the air supply and the restricted environment, and the ventilator 30 can be connected in an external manner to said single tube.

In the present embodiment, the ventilator 30 can be powered by connecting it to a low-current electrical outlet, such as a DC connector. For example, the ventilator 30 can be connected to a 12V accessory socket, generally found in vehicles. In some embodiments, the ventilator 30 can be adapted to produce an airflow between about 150 CFM (cubic feet per meter) and about 250 CFM during operation thereof. However, it is appreciated that alternate airflow outputs can be suitable in this context.

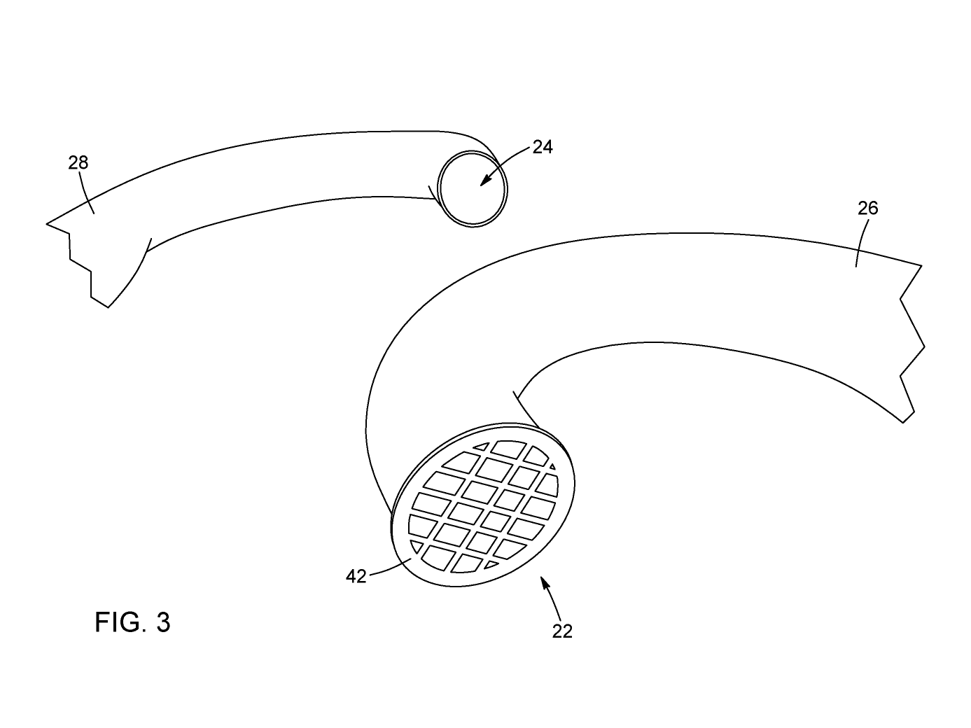

Now referring back to FIG. 1, in order to increase flexibility and/or maneuverability of the tubing assembly 20, at least one of the tubes 26, 28 can be provided with an accordion section 40. As should be understood by a person skilled in the art, the accordion section 40 can allow the tubes to expand longitudinally while simultaneously increasing the flexibility thereof. In the present embodiment, both the upstream tube 26 and the downstream tube 28 is respectively provided with an accordion section 40. Moreover, it is appreciated that the accordion section 40 can extend for substantially an entire length of the tubes, as illustrated in FIG. 1. However, it is appreciated that the tubes can be provided with a plurality of shorter accordion sections 40, and that the accordion section can extend along any suitable length of one, or both tubes. Additionally, and with reference to FIG. 3, the inlet 22 of the tubing assembly 20 can be provided with a grate 42 adapted to prevent debris from entering the tubing assembly 20 and passing through the ventilator, potentially damaging it. It is appreciated that the outlet 24 can be provided with a secondary grate (not shown) adapted to prevent debris from exiting the tubing assembly 20, and ultimately entering the restricted environment.

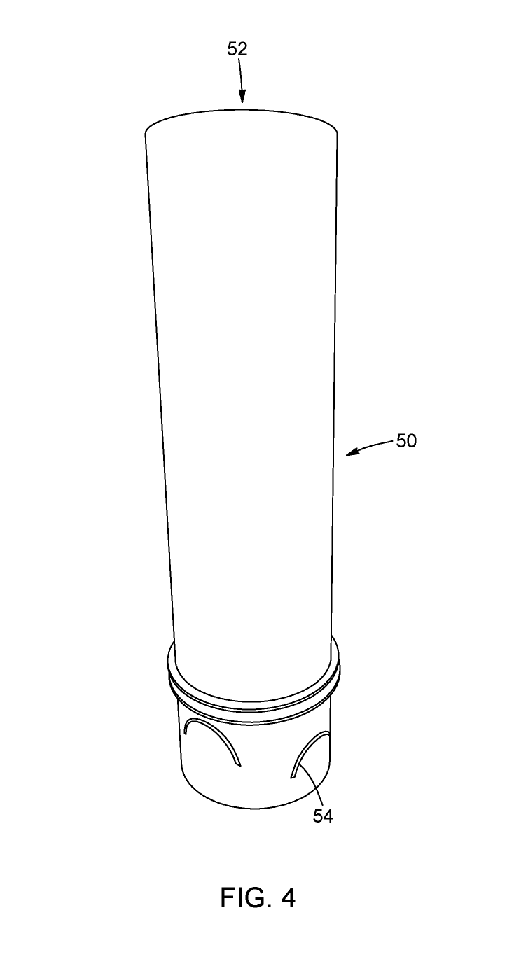

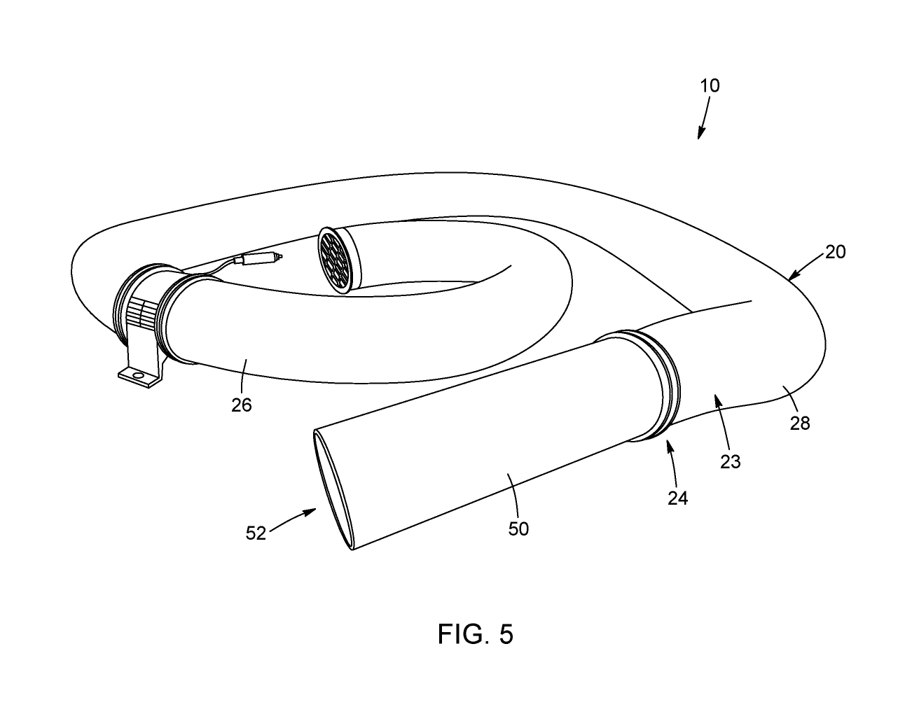

With reference to FIGS. 4 through 7, the apparatus 10 can comprise an attachment 50 removably connectable to the outlet 24 (or second end 23) so as to function as an extension of the tubing assembly 20. It is understood that, in this embodiment, the attachment 50 is in fluid communication with the tubing assembly 20. Moreover, the attachment 50 can comprise an opening 52 adapted to be inserted within the restricted environment in order to have said environment be in fluid communication with the tubing assembly 20. As such, the airflow provided by the air supply can travel through the tubing assembly 20, towards the outlet 24 and finally within the restricted environment via the attachment 50.

In some embodiments, the attachment 50 can be substantially tubular and have a base 54 connectable to the outlet 24 of the tubing assembly 20. The base 54 can be substantially rigid so as to effectively connect with the outlet 24 in a secure manner. In this embodiment, the base 54 is adapted to be removably connected to the tubing assembly 20 by manually inserting the base within the outlet 24. Therefore, it is understood that connecting the attachment 50 to the tubing assembly 20 can be facilitated by the tool-less manipulation/connection. It is appreciated that the connection between the attachment 50 (i.e. the base 54) and the outlet 24 can be further secured with the use of fasteners, such as Velcro® or clamps for example, or any other suitable fastener and/or fastening method.

In this embodiment, the attachment 50 is made from a flexible/malleable material allowing the attachment, or at least the opening 52 thereof, to be manually deformed/adjusted in order to have it be inserted within the restricted environment. More specifically, by applying pressure on the attachment 50, the opening 52 can be adjusted to the required size in order to access the restricted environment. For example, the opening can be squeezed and deformed to fit under a locked and/or blocked door, or within a parked vehicle with through an opening in the window.

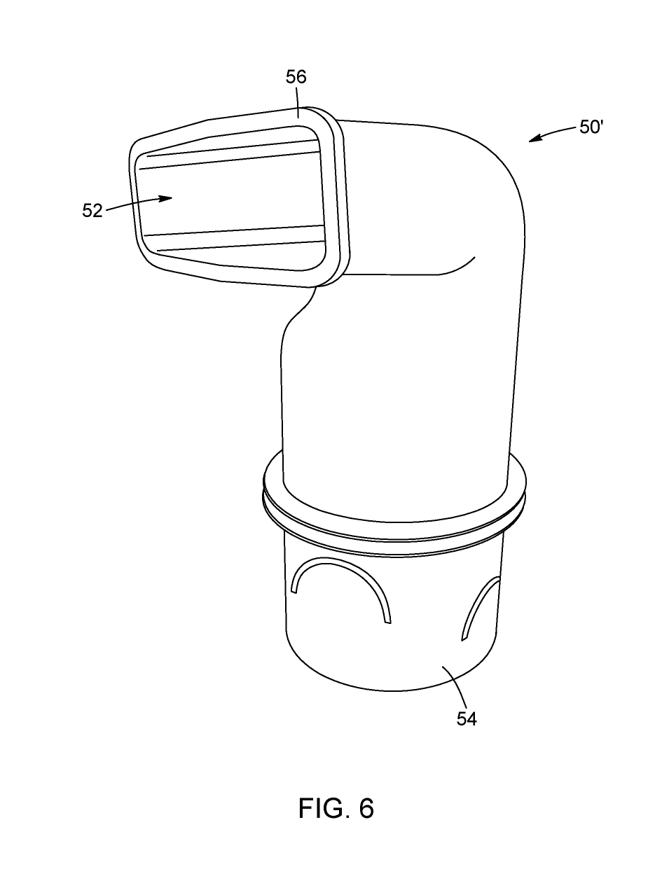

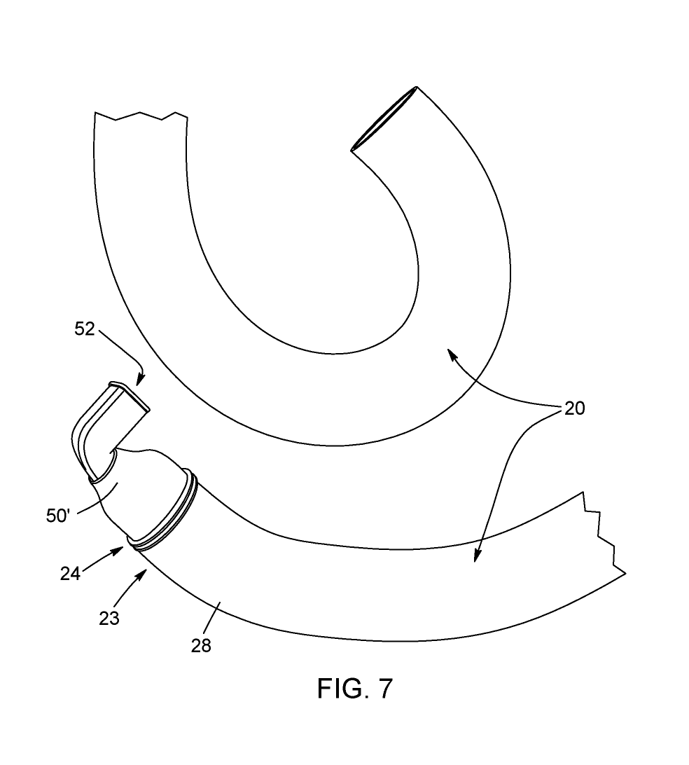

As seen in FIG. 4, the attachment 50 can be elongated and substantially straight. Alternatively, the attachment 50 can have any suitable shape and size, such as an L-shape, as seen in the embodiment of FIGS. 6 and 7, or a J-shape allowing the attachment to be hooked on an open window of a vehicle for example. Additionally, the opening 52 can be provided with a flange 56 (FIG. 6) extending around a periphery thereof. In this embodiment, the flange 56 is adapted to prevent accidental removal of the attachment 50 from within the restricted environment. More particularly, the flange 56 can abut against an inner side of the restricted environment so as to remain within said environment.

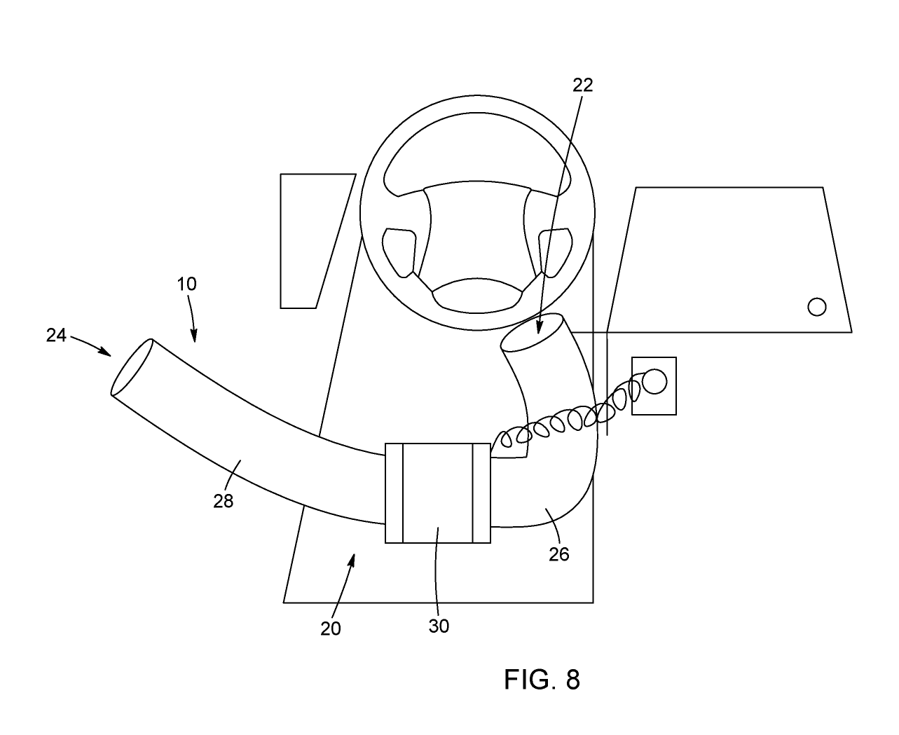

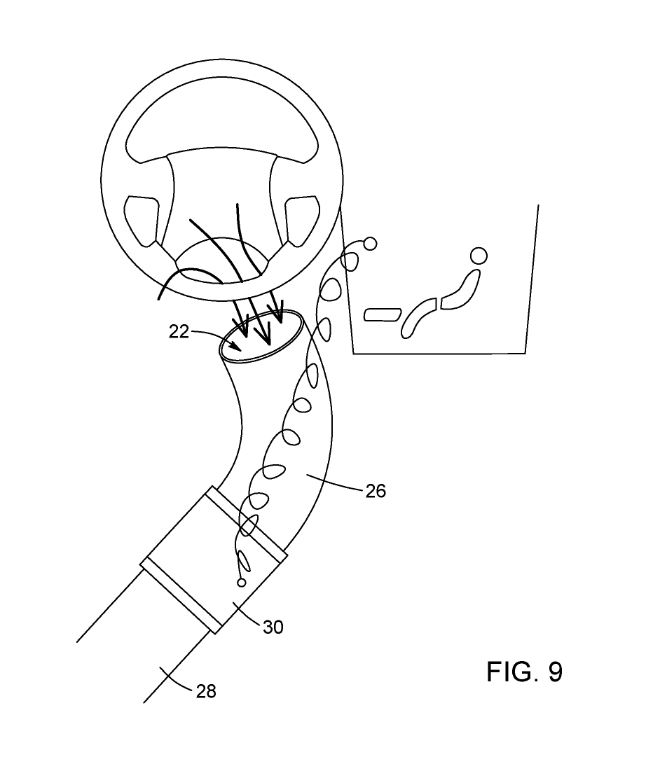

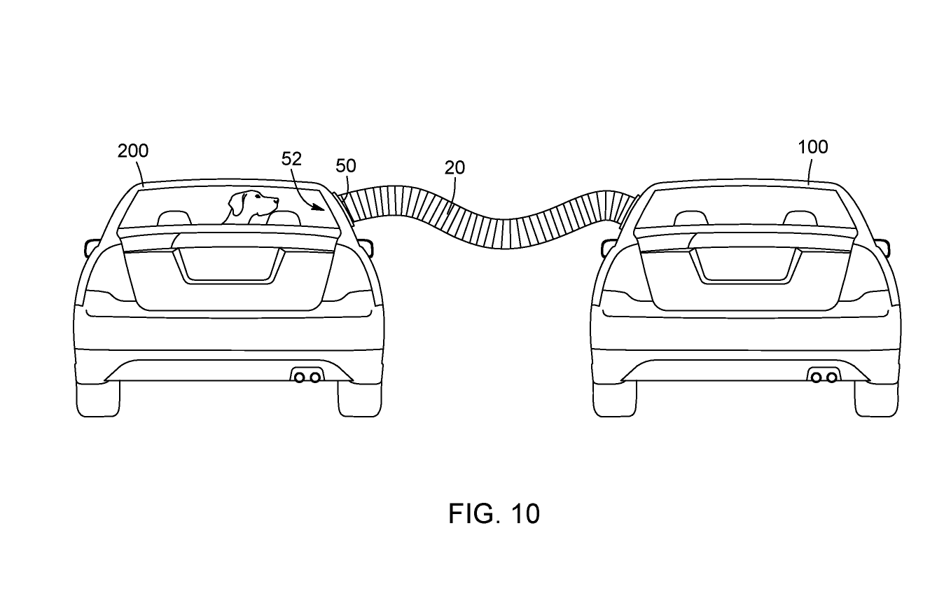

In an exemplary application, and with reference to FIGS. 8 to 10, the air transfer apparatus 10 can be used to transfer air from a first vehicle 100 to a second vehicle 200. As previously mentioned, a pet such as a dog, or any other animal, can be located within the second vehicle 200 during a hot and sunny day. Generally, a small opening will be left in the windows of the second vehicle 200 to provide air to the animal. However, such openings are often insufficient at keeping the interior temperature of the second vehicle cool enough for the animal. As such, the air transfer apparatus 10 can be used to provide fresh/cool air to the animal from the first vehicle. Thus, in this embodiment, the air supply is the first vehicle's air conditioning (A/C) system. In the present embodiment, the inlet 22 of the tubing assembly 20 can be positioned in a manner to cooperate with one of the air conditioning vents of the first vehicle 100. Preferably, the upstream tube 26 is positioned on the floor of the vehicle, either on the driver-side or the passenger-side, and is positioned to cooperate with one of the lower A/C vents, as exemplified in FIGS. 8 and 9. The attachment 50 is then inserted within the small opening of the window of the second vehicle 200 by squeezing the opening 52 to the required size to access said second vehicle 200. Once the attachment 50 is in place, the ventilator 30, which is connected to the first vehicle's 12V accessory socket, can be operated in order to direct the airflow provided by the first vehicle's A/C within the second vehicle 200 to provide cool/fresh air to the animal.

It should be appreciated that the air transfer apparatus 10 can be used for other applications. For example, the apparatus 10 can be included in a kit, such as a rescue kit, for helping people in various situations. A non-limiting example of such a situation can be natural disasters, such as earthquakes and tornadoes for example, which can leave people stranded in restricted environments. Therefore, the rescue kit can be carried by rescue workers in order to aid these people. In this embodiment, the air supply can be an air compressor for example, providing the airflow to the tubing assembly 20 of the apparatus 10. It is appreciated that any other suitable air supplying device/apparatus known in the art could be used for rescue operations

In some embodiments, the rescue kit can include a plurality of tools and equipment. For example, the kit can include, among others, one or more of the following items: a water bottle, a towel, a sun shade cover, a thermoreflective cover, a window-punch, a knife, a digital temperature reader, a flashlight, a distress light, and an AC to DC adapter.

1. An air transfer apparatus for transferring air from an air supply to a restricted environment, the air transfer apparatus comprising:
a tubing assembly having an inlet and an outlet, the inlet cooperating with the air supply to produce an airflow within the tubing assembly;
an attachment removably connected to the outlet of the tubing assembly, the attachment being in fluid communication with the tubing assembly and having an opening insertable within the restricted environment; and
a ventilator operably connected to the tubing assembly;
wherein operating the ventilator directs the airflow within the tubing assembly towards the outlet and within the restricted environment via the attachment.

2. The air transfer apparatus according to claim 1, wherein the opening of the attachment is manually adjustable to allow insertion within the restricted environment.

3. The air transfer apparatus according to claim 1, wherein the attachment is tubular and comprises a rigid base connectable to the outlet of the tubing assembly.

4. The air transfer apparatus according to claim 1, wherein the attachment is substantially straight.

5. The air transfer apparatus according to claim 1, wherein the attachment is L-shaped.

6. The air transfer apparatus according to claim 1, wherein the opening of the attachment has a periphery provided with an outer flange.

7. The air transfer apparatus according to claim 1, wherein the tubing assembly comprises an upstream tube provided with the inlet, and a downstream tube provided with the outlet, the upstream and downstream tubes being in fluid communication with one another.

8. The air transfer apparatus according to claim 7, wherein at least one of the upstream and downstream tubes is provided with an accordion section to increase flexibility and allow a longitudinal expansion thereof.

9. The air transfer apparatus according to claim 8, wherein the accordion section extends for an entire length of the corresponding tube.

10. The air transfer apparatus according to claim 7, wherein the ventilator is a portable fan having a first side and a second side, and wherein the upstream tube is operably connected to the first side, and the downstream tube is operably connected to the second side.

11. The air transfer apparatus according to claim 1, wherein the ventilator is connectable to a standard DC connector.

12. The air transfer apparatus according to claim 1, wherein the airflow is between about 150 CFM and about 270 CFM during operation of the ventilator.

13. The air transfer apparatus according to claim 1, wherein the inlet of the tubing assembly is provided with a grate.

14. The air transfer apparatus according to claim 1, wherein the air supply is an air conditioning vent.

15. The air transfer apparatus according to claim 1, wherein the restricted environment is a vehicle.

16. A kit comprising the air transfer apparatus of claim 1, and a plurality of rescue tools.

17. The kit according to claim 16, wherein the rescue tools are selected from a group consisting of a water bottle, a towel, a sun shade cover, a thermoreflective cover, a window-punch, a knife, a digital temperature reader, a flashlight, a distress light, and an AC to DC adapter.

18. A method of providing an airflow to a restricted environment using the air transfer apparatus according to claim 1, the method comprising the steps of:
a. connecting the attachment to the outlet of the tubing assembly;
b. manually adjusting/squeezing the attachment to insert the opening thereof within the restricted environment;
c. positioning the inlet of the tubing assembly for cooperating with the air supply;
d. operating the ventilator to provide airflow to the restricted environment.
